(19) United States
(12) Patent Application Publication
(10) Pub. No.: US 2009/0171917 A1
(43) Pub. Date: Jul. 2, 2009

(54) METHOD FOR OPENING FILE

(75) Inventor: Fu-Chiang Chou, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: HTC CORPORATION, Taoyuan County (TW)

(21) Appl. No.: 12/344,272

(22) Filed: Dec. 25, 2008

(30) Foreign Application Priority Data
Dec. 31, 2007 (TW) 96151540

(51) Int. Cl. G06F 17/30; G06F 17/21

(52) U.S. Cl. 707/3; 707/10; 715/273; 707/E17.01; 707/E17.108; 707/E17.032; 707/E17.008

(57) ABSTRACT

A method for opening a file is provided. The method is suitable for a device storing at least one file, wherein a web browser is installed in the device. First, an application program for opening the file is searched for in both the device and the internet. Then, if the application program is provided by a server on the internet, the file is uploaded to the server. Next, the file is opened in the server by using the application program. Thereafter, the file is displayed in the device through the web browser.

### CROSS-REFERENCE TO RELATED APPLICATION

This application claims the priority benefit of Taiwan application serial no. 96151540, filed on Dec. 31, 2007. The entirety of the above-mentioned patent application is hereby incorporated by reference herein and made a part of this specification.

### BACKGROUND OF THE INVENTION

1. Field of the Invention

The present invention generally relates to a file operation method, and more particularly, to a file opening method.

2. Description of Related Art

Along with the advancement of digital technologies, portable electronic devices, such as cell phones or personal digital assistants (PDAs), have become increasingly popular due to their high portability. A user can perform video communications and send e-mails, short messages, and multimedia messages by using a portable communication device.

However, since a portable device has very limited storage space, only some basic application programs can be installed therein. Accordingly, when a user uses a portable device for opening a file, a message like “no related application program is available” will be displayed in the portable device if no appropriate application program for opening the file is installed in the portable device. If this happens in an existing desktop computer, two options of “select the program from a list” and “use the web service to find the appropriate program” will be displayed, wherein the option of “use the web service to find the appropriate program” is to find the related application program for opening the file on the internet.

### SUMMARY OF THE INVENTION

Accordingly, the present invention is directed to a file opening method, wherein a user can read a file displayed in a portable device through a web browser without performing any complicated manual operation.

The present invention is also directed to a file opening method, wherein an appropriate application program is selected from both a device and an internet according to a customized condition and used for opening a file automatically.

The present invention is further directed to a file opening method, wherein it is made very convenient for a user to open a file.

The present invention provides a file opening method suitable for a device storing at least one file, wherein a web browser is installed in the device. First, an application program for opening a file is searched for in both the device and an internet. Then, if the application program is provided by a first server on the internet, the file is uploaded to the first server. Next, the file is opened in the first server by using the application program. Thereafter, the file is displayed in the device through the web browser.

According to an embodiment of the present invention, in the file opening method, the step of searching for the application program in both the device and the internet further includes following steps. First, whether there is at least one first program for opening the file in the device is determined, and an application program request is transmitted by the device to a second server. Then, a response is transmitted by the second server to the device according to the application program request, wherein the response includes a plurality of second programs for opening the file. Next, one of the first program and the second programs is selected as the application program according to a customized condition. The second server is a web server or a server in the device. In addition, the second server stores a plurality of file types and respectively lists a plurality of application programs for opening each of the file types, and the second server respectively lists a plurality of network services for providing each of the application programs and a connection path corresponding to each of the network services.

In addition, the file opening method in the present invention further includes directly opening the file in the device by using the first program if the first program is selected as the application program. The customized condition is that a network service for providing the application program is a free service or an application program attribute of the application program includes a latest edition, a professional edition, or a latest release date. In addition, the step of uploading the file to the first server further includes establishing a connection between the device and the first server which provides the application program and then uploading the file to the first server.

According to an embodiment of the present invention, the file opening method further includes displaying a message of “no appropriate program is found” in the device if the application program for opening the file is found in neither the device nor the internet.

According to an embodiment of the present invention, in the file opening method, the first server includes a web server.

According to an embodiment of the present invention, in the file opening method, the first server is an application service provider (ASP).

According to an embodiment of the present invention, in the file opening method, the device is one of a personal computer, a personal digital assistant (PDA) phone, a smartphone, and a touch phone.

The present invention further provides a file opening method suitable for a device storing various files, wherein a web browser is installed in the device. First, a request is transmitted by the device to a first server according to the file. Then, a response is transmitted by the first server to the device according to the request. Next, if the response includes a plurality of first programs for opening the file, one of the first programs is selected as an application program for opening the file. Thereafter, a connection between the device and a second server which provides the application program is established. Next, the file is uploaded to the second server. After that, the file is opened in the second server by using the application program. Next, the file is displayed in the device through the web browser.

According to an embodiment of the present invention, in the file opening method, the first server stores a plurality of file types and respectively lists a plurality of application programs for opening each of the file types, and the first server respectively lists a plurality of network services for providing each of the application programs and a connection path corresponding to each of the network services.

According to an embodiment of the present invention, in the file opening method, the step of selecting the application program further includes selecting the application program according to a customized condition, wherein the customized condition is that a network service for providing the application program is a free service or an application program attribute of the application program includes a latest edition, a professional edition, or a latest release date.

According to an embodiment of the present invention, after the step of transmitting the response to the device by using the first server, the file opening method further includes displaying a message of “no appropriate program is found” in the device if the response indicates that the application program for opening the file is not found.

According to an embodiment of the present invention, in the file opening method, the device is one of a personal computer, a PDA phone, a smartphone, and a touch phone.

According to an embodiment of the present invention, in the file opening method, the first server is a web server or a server in the device.

According to an embodiment of the present invention, in the file opening method, the second server includes a web server.

According to an embodiment of the present invention, in the file opening method, the second server is an ASP.

The present invention further provides a file opening method suitable for a device storing at least one file, wherein a web browser is installed in the device. First, an application program for opening the file is searched for in the device. Then, the file is directly opened in the device by using the application program if the application program for opening the file is found in the device. If the application program for opening the file is not found in the device, a request is transmitted by the device to a first server. Next, a response is transmitted by the first server to the device according to the request. Thereafter, if the response includes a plurality of first programs for opening the file, one of the first programs is selected as the application program for opening the file. After that, a connection between the device and a second server which provides the application program is established. Then, the file is uploaded to the second server. Next, the file is opened in the second server by using the selected first program. Thereafter, the file is displayed in the device through the web browser.

According to an embodiment of the present invention, in the file opening method, the first server is a web server or a server in the device.

According to an embodiment of the present invention, in the file opening method, the first server stores a plurality of file types and respectively lists a plurality of application programs for opening each of the file types, and the first server respectively lists a plurality of network services for providing each of the application programs and a connection path corresponding to each of the network services.

According to an embodiment of the present invention, in the file opening method, the step of selecting one of the first programs as the application program further includes selecting one of the first programs as the application program according to a customized condition, wherein the customized condition is that a network service for providing the application program is a free service or an application program attribute of the application program includes a latest edition, a professional edition, or a latest release date.

According to an embodiment of the present invention, in the file opening method, the step of uploading the file to the second server further includes establishing a connection between the device and the second server which provides the selected first program and then uploading the file to the second server.

According to an embodiment of the present invention, the file opening method further includes displaying a message of “no appropriate program is found” in the device if the application program for opening the file is not found in the device and the response also indicates that the application program for opening the file is not found.

According to an embodiment of the present invention, in the file opening method, the second server includes a web server.

According to an embodiment of the present invention, in the file opening method, the second server is an ASP.

According to an embodiment of the present invention, in the file opening method, the device is one of a personal computer, a PDA phone, a smartphone, and a touch phone.

In the present invention, when a user opens a file in a device, the file can be opened by using an application program installed in the device or an appropriate application program found on the internet. After comparing the application program installed in the device and the application programs found on the internet, the most suitable application program is selected for opening the file. In addition, according to the present invention, when a user opens a file in a device, the file is uploaded to a server and then opened in the server by using an application program. After that, the file is displayed in the device through a web browser. Thus, the storage space required for installing application programs in the device is greatly reduced. Moreover, according to the present invention, the device automatically transmits a request to a web server to search for an appropriate application program, and the web server provides a list of application programs to the device according to this request. Thus, a user needs not to look for the desired application program on the internet by himself, and accordingly, it is made very convenient for the user to use the device.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart of a file opening method according to an embodiment of the present invention.

FIG. 2 is a flowchart of a file opening method according to another embodiment of the present invention.

FIG. 3 is a flowchart of a file opening method according to yet another embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

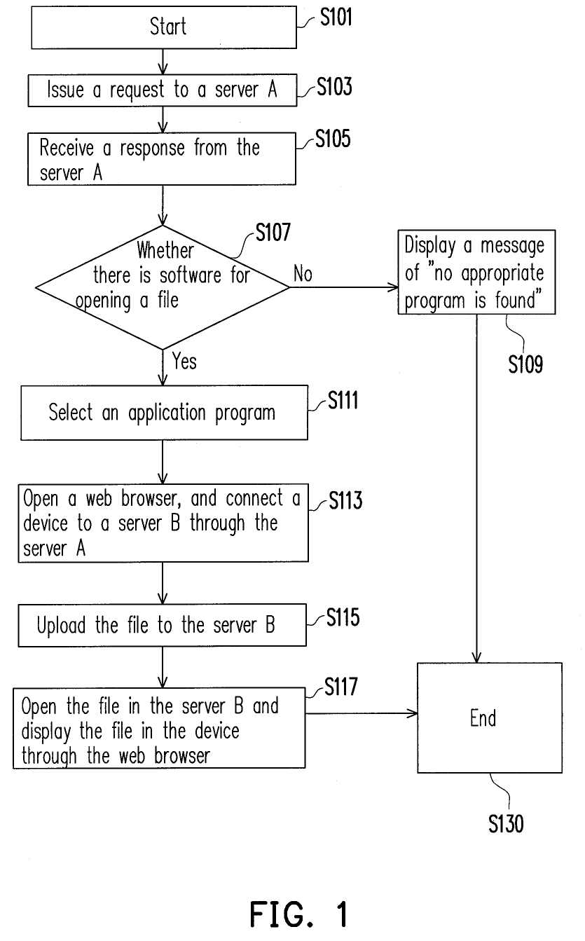

FIG. 1 is a flowchart of a method for opening a file according to an embodiment of the present invention. Referring to FIG. 1, first, in step S101, a user selects a file stored in a device to open the file, wherein the device may be a personal computer, a personal digital assistant phone (PDA phone), a smartphone, or a touch phone, and the file may be a text file or a multimedia file. Besides, a web browser is installed in the device. Then, in step S103, a request (i.e., an application program request) is sent to a server A to request the server A to provide a list of application programs for opening the file. The request contains the extension or type of the file. Next, in step S105, the server A transmits a response (i.e., a search result response) to the device according to the request received from the device (i.e., according to the file which is to be opened in the device). The server A stores a plurality of file types and correspondingly lists a plurality of application programs for opening each of the file types, and the server A respectively lists a plurality of network services for providing each of the application programs and a connection path corresponding to each of the network services (for example, the web address of a server which provides the network service). The server A may be a web server or a server in the device, and the web server may be a proxy server.

In step S107, whether there is software (i.e., an application program) for opening the file is determined according to the response transmited by the server A. If the response of the server A indicates that no software for opening the file is found, in step S109, a message of “no appropriate program is found” is displayed in the device, and in step S130, the file opening process is ended. If the response of the server A includes a program list, namely, the server A determines that there is software for opening the file, in step S111, one of the programs in the program list is selected as the application program for opening the file. The program list lists a plurality of application programs for opening the file, and in step S111, one of the programs in the program list is selected as the application program for opening the file according to a customized condition. The customized condition includes that a network service for providing the application program is a free service or an application program attribute of the application program shows that the application program is of a latest edition, a professional edition, or the application program has a latest release date.

In step S113, a web browser installed in the device is opened, and a connection between the device and a server B which provides the selected application program is established, wherein the server B may be a web server. The server B is an application service provider (ASP).

In step S115, the file is uploaded to the server B through foregoing connection. After that, in step S117, the file is opened in the server B by using the application program provided by the network service thereof. At the same time, the file is displayed in the device through the web browser, and the file opening process is ended in step S130. The file opened by using the application program in the server (for example, an image file or pages provided by the application program on the server, or a readable image converted and processed by the application program on the server) is displayed through a web browser in the device.

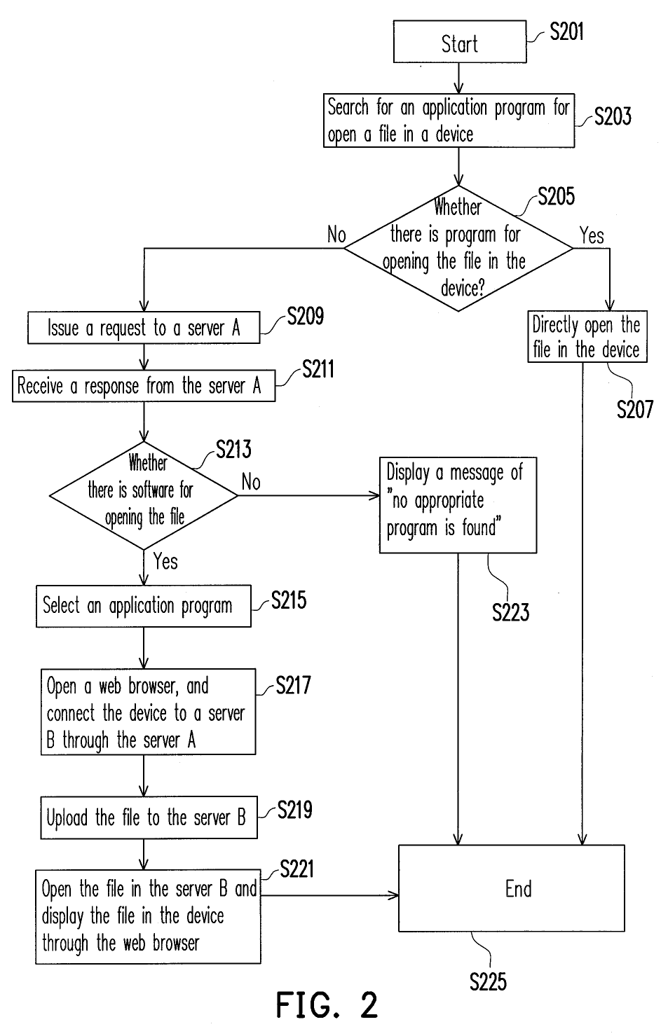

In the present embodiment, while opening the file, the device is directly connected to the server A and transmits a request thereto (step S103). However, the present invention is not limited thereto. In another embodiment of the present invention, referring to FIG. 2, while opening the file (i.e., after step S201), an application program for opening the file is searched for in the device (step S203). Then, whether there is a program for opening the file in the device is determined (step S205). If an application program for opening the file is found in the device, the file is directly opened by using the application program in the device (step S207) and the file opening process is ended (S225). If there is no application program for opening the file is found in the device, step S209 is executed to transmit a request to the server A to request the server A to provide a list of application programs for opening the file. Next, the server A transmits a response to the device according to the received request (step S211). In step S213, whether there is software (i.e., an application program) for opening the file is determined according to the response received from the server A. In step S215, if the response contains a program list which includes a plurality of programs for opening the file, one of the programs in the program list is selected as the application program for opening the file. After that, in step S217, a connection between the device and the server B which provides the application program is established. Next, in step S219, the file is uploaded to the server B. In step S221, the file is opened by using the selected program in the server B, and meanwhile, the file is displayed in the device through a web browser. For example, the uploaded file is displayed through the web browser as an image file or pages provided by the application program in the server B or a readable image presented after the file is converted and processed by the application program in the server. After that, the file opening process is ended in step S225. However, if no application program for opening the file is found in the device and the response received from the server A also indicates that no application program for opening the file is found, a message of “no appropriate program is found” is displayed in the device (step 223).

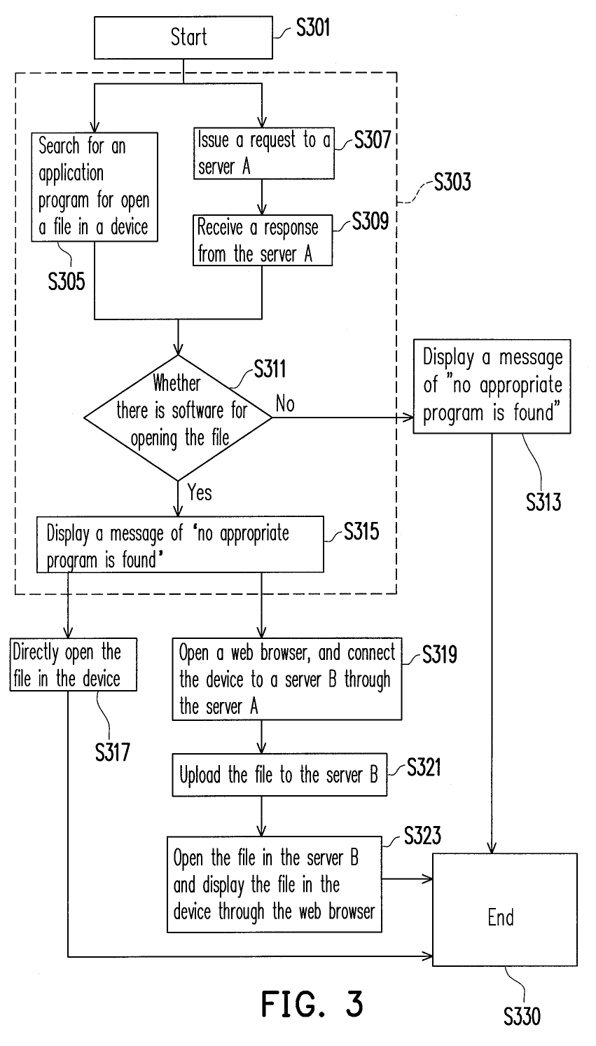

In the embodiment described above, if no application program for opening the file is found in the device, the device is directly connected to the server A and transmits a request of the program list and selects the desired application program from the program list. However, the present invention is not limited thereto. FIG. 3 is a flowchart of a method for opening a file according to yet another embodiment of the present invention. Referring to FIG. 3, first, in step S301, a user selects a file stored in a device to open the file, wherein the device may be a personal computer, a PDA phone, a smartphone, or a touch phone. Besides, a web browser is installed in the device. Then, in step S303, an application program for opening the file is respectively searched for in the device and the internet. In step S307, when the application program for opening the file is searched for in the device, a request is transmited by the device to a server A to request the server A to provide a list of application programs for opening the file. The content of the request transmitted by the device to the server A has been described in foregoing embodiment therefore will not be described herein. After that, in step S309, the server A transmits a response to the device according to the request received from the device, namely, according to the file which is to be opened in the device. The data stored in the server A and the types thereof have been described in foregoing embodiment therefore will not be described herein.

Thereafter, in step S311, whether there is software for opening the file is determined. If no application program for opening the file is found in the device and the response received from the server A also indicates that no software for opening the file is found, a message of “no appropriate program is found” is displayed in the device in step S313, and the file opening process is ended in step S330. If a software for opening the file is found in the device or the response received from the server A includes a program list, namely, the server A determines that there is software for opening the file, in step S315, one of the programs in the program list and the application program installed in the device is selected as the application program for opening the file. In other words, regardless of whether the available application program is in the device or the server A provides the information of a software for opening the file, step S315 is executed as long as it is determined in step S311 that there is an application program for opening the file in the device or the server A.

Accordingly, in step S315, one of the application program in the device and the programs in the program list is selected according to a customized condition or manually by the user and served as the application program for opening the file. The customized condition includes that a network service for providing the application program is a free service or an application program attribute of the application program indicates that the application program is of a latest edition, a professional edition, or the application program has a latest release date.

If the selected application program for opening the file is in the device, the file is directly opened in the device in step S317. Otherwise, if the selected application program for opening the file is one of the application programs in the program list, in step S319, a web browser installed in the device is opened, and a connection between the device and a server B for providing the application program is established, wherein the server B may be a web server. The server B supports active server pages, namely, the server B is an ASP.

In step S321, the file is uploaded to the server B through foregoing connection. Then, in step S323, the file is opened in the server B by using the application program provided by the network service. Meanwhile, the file is displayed in the device through the web browser as an image file or pages provided by the application program in the server, or a readable image converted and processed by the application program in the server. After that, the file opening process is ended (step S330).

As described above, the present invention provides a method for opening a file, wherein when a user opens a file by using a device, the file can be opened by using an application program installed in the device or an appropriate application program found on the internet. After comparing the application program installed in the device and the application programs found on the internet, the most suitable application program is selected for opening the file. Moreover, the file is uploaded to the server and then opened in the server by using the selected application program, and meanwhile, the file is displayed in the device through a web browser as an image file or pages of the file provided by the application program in the server or a readable image converted and processed by the application program in the server. Thus, the storage space required for installing application programs in the device is greatly reduced. Furthermore, according to the present invention, the device automatically transmits a request for searching for an appropriate application program to the web server, and the web server provides a list of application programs to the device according to the request. Thus, the user needs not to search for the desired application program on the internet by himself so that it is made very convenient for the user to use the device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for opening a file, suitable for a device storing at least one file, wherein a web browser is installed in the device, the method comprising:
searching for an application program for opening the file in both the device and an internet;
if the application program is provided by a first server, which is the first server is a web server or an application service provider (ASP), on the internet:
uploading the file to the first server;
opening the file in the first server by using the application program; and
displaying the file in the device through the web browser.

2. The method according to claim 1, wherein the step of searching for the application program in both the device and the internet further comprises:
determining at least a first program in the device for opening the file, and transmitting an application program request to a second server by using the device, wherein the second server is a web server or a server in the device;
transmitting a response to the device according to the application program request by using the second server, wherein the response comprises a plurality of second programs for opening the file; and
selecting one of the first program and the second programs as the application program according to a customized condition.

3. The method according to claim 2, wherein the second server stores a plurality of file types and respectively lists a plurality of application programs for opening each of the file types, and the second server respectively lists a plurality of network services for providing each of the application programs and a connection path corresponding to each of the network services.

4. The method according to claim 2 further comprising directly opening the file in the device by using the first program when the first program is selected as the application program.

5. The method according to claim 2, wherein the customized condition is that a network service for providing the application program is a free service or an application program attribute of the application program comprises a latest edition, a professional edition, or a latest release date.

6. The method according to claim 2, wherein the step of uploading the file to the first server further comprises:
establishing a connection between the device and the first server which provides the application program; and
uploading the file to the first server.

7. The method according to claim 1 further comprising displaying a message of “no appropriate program is found” in the device if the application program for opening the file is found in neither the device nor the internet.

8. A method for opening a file, suitable for a device storing various files, wherein a web browser is installed in the device, the method comprising:
transmitting a request to a first server according to the file by using the device, wherein the first server is a web server or a server in the device;
transmitting a response to the device according to the request by using the first server;
if the response comprises a plurality of first programs for opening the file:
selecting one of the first programs as an application program for opening the file;
establishing a connection between the device and a second server which provides the application program, wherein the second server is a web server or an ASP;
uploading the file to the second server;
opening the file in the second server by using the application program; and
displaying the file in the device through the web browser.

9. The method according to claim 8, wherein the first server stores a plurality of file types and respectively lists a plurality of application programs for opening each of the file types, and the first server respectively lists a plurality of network services for providing each of the application programs and a connection path corresponding to each of the network services.

10. The method according to claim 8, wherein the step of selecting the application program further comprises selecting the application program according to a customized condition.

11. The method according to claim 10, wherein the customized condition is that a network service for providing the application program is a free service or an application program attribute of the application program comprises a latest edition, a professional edition, or a latest release date.

12. The method according to claim 8, wherein after the step of transmitting the response to the device by using the first server, the method further comprises displaying a message of “no appropriate program is found” in the device if the responses indicates that the application program for opening the file is not found.

13. A method for opening a file, suitable for a device storing at least one file, wherein a web browser is installed in the device, the method comprising:
searching for an application program for opening the file in the device;
directly opening the file in the device by using the application program when the application program for opening the file is found in the device;
transmitting a request to a first server by using the device if the application program for opening the file is not found in the device;
transmitting a response to the device according to the request by using the first server;
if the response comprises a plurality of first programs for opening the file:
selecting one of the first programs as the application program for opening the file;
establishing a connection between the device and a second server which provides the application program, wherein the second server is a web server or an ASP;
uploading the file to the second server;
opening the file in the second server by using the selected first program;
displaying the file in the device through the web browser; and
displaying a message of “no appropriate program is found” in the device if the application program for opening the file is not found in the device and the response also indicates that the application program for opening the file is not found.

14. The method according to claim 13, wherein the first server is a web server or a server in the device.

15. The method according to claim 13, wherein the first server stores a plurality of file types and respectively lists a plurality of application programs for opening each of the file types, and the first server respectively lists a plurality of network services for providing each of the application programs and a connection path corresponding to each of the network services.

16. The method according to claim 13, wherein the step of selecting one of the first programs as the application program further comprises selecting one of the first programs as the application program according to a customized condition.

17. The method according to claim 16, wherein the customized condition is that a network service for providing the application program is a free service or an application program attribute of the application program comprises a latest edition, a professional edition, or a latest release date.

18. The method according to claim 13, wherein the step of uploading the file to the second server further comprises:
establishing a connection between the device and the second server which provides the selected first program; and
uploading the file to the second server.
